(19) United States
(12) Patent Application Publication
(10) Pub. No.: US 2024/0160830 A1
(43) Pub. Date: May 16, 2024

(54) INFORMATION PROCESSING APPARATUS, IMAGE GENERATING APPARATUS, METHODS FOR CONTROLLING INFORMATION PROCESSING APPARATUS AND IMAGE GENERATING APPARATUS, INFORMATION PROCESSING SYSTEM, AND STORAGE MEDIUM

(71) Applicant: CANON KABUSHIKI KAISHA, Tokyo (JP)

(72) Inventor: YUUSEI SASAKI, Hokkaido (JP)

(21) Appl. No.: 18/505,847

(22) Filed: Nov. 9, 2023

(30) Foreign Application Priority Data
Nov. 11, 2022 (JP) 2022-181243

(51) Int. Cl. G06F 40/106; G06F 3/04845; G06F 3/0485

(52) U.S. Cl. CPC G06F 40/106; G06F 3/04845; G06F 3/0485; G06F 2203/04806

(57) ABSTRACT

An information processing apparatus receives an image of a partial region of a Web page, from an external image generating apparatus that renders the Web page, and displays the image on a display unit. The information processing apparatus, when a user operation for changing the image displayed on the display unit is accepted, determine whether or not there will be a change in the image as a result of applying the user operation. The information processing apparatus transmits information regarding the user operation to the image generating apparatus in order to obtain an image to which the user operation has been applied. Here, the information processing apparatus, if it is determined that there will be no change in the image, restricts transmission of the information regarding the user operation to the image generating apparatus.

### BACKGROUND

### Field of the Disclosure

The present disclosure relates to an information processing apparatus, an image generating apparatus, methods for controlling the information processing apparatus and the image generating apparatus, an information processing system, and a storage medium.

### Description of the Related Art

Communication terminals in which a Web browser (hereinafter, “browser”) is implemented, and that enable a user to view a Web page on the browser are in widespread use. The communication terminals can operate in cooperation with an external service by displaying a Web page of the external service through the browser. On the other hand, as an aspect of a browser, there is an aspect called a cloud browser for disposing, on a cloud server, a browser engine that generates a rendering result of a Web page. The cloud browser makes it possible to view a Web page on a communication terminal by transmitting, to the communication terminal, an image that is based on a result of rendering performed by the browser engine on the server. The browser engine performs processing that involves a high calculation load such as processing for analyzing or executing a Web page, and thus the cloud browser that executes the browser engine on the server reduces a calculation load on the communication terminal.

With the cloud browser, the communication terminal and the server need to perform communication with each other, and thus, compared with a Web browser incorporated in a communication terminal, a time for communication is additionally required to display a Web page. Japanese Patent Laid-Open No. 2014-182793 (hereinafter, Patent Document 1) proposes a technique for reducing a load by generating a difference frame for a top frame or a previously obtained rendering result, if a period during which a Web page that is being rendered by a cloud browser is not updated is shorter than a predetermined time.

When a Web page rendered by the cloud browser is viewed using the communication terminal, and a user operation for changing a display content such as a scroll operation is accepted, the communication terminal notifies the cloud browser of the user operation in order to obtain a changed image. For this reason, when a user operation occurs, communication occurs between the communication terminal and the cloud browser. In Patent Document 1, a communication amount is reduced by using a difference frame. However, there are cases where no change is made in an image (display content) even when a user operation is accepted, and Patent Document 1 does not take such cases into consideration. Therefore, unnecessary communication may occur.

### SUMMARY

The present disclosure provides a technique for reducing the occurrence of communication that occurs in accordance with a user operation, in a configuration for receiving an image of a Web page from an external apparatus and displaying the image.

According to one aspect of the present disclosure, there is provided an information processing apparatus comprising: a display control unit configured to receive an image of a partial region of a Web page, from an external image generating apparatus that renders the Web page, and to display the image on a display unit; a determining unit configured to, when a user operation for changing the image displayed on the display unit is accepted, determine whether or not there will be a change in the image as a result of applying the user operation; and a transmitting unit configured to transmit information regarding the user operation to the image generating apparatus in order to obtain an image to which the user operation has been applied, wherein if it is determined that there will be no change in the image, the transmitting unit restricts transmission of the information regarding the user operation to the image generating apparatus.

Further features of the present disclosure will become apparent from the following description of exemplary embodiments with reference to the attached drawings.

### BRIEF DESCRIPTION OF THE DRAWINGS

FIG. 1 is a block diagram showing a configuration example of an information processing system according to one or more aspects of the present disclosure.

FIG. 2 is a block diagram showing an exemplary hardware configuration of a communication terminal according to one or more aspects of the present disclosure.

FIG. 3 is a block diagram showing an exemplary functional configuration of the communication terminal according to one or more aspects of the present disclosure.

FIG. 4 is a block diagram showing an exemplary hardware configuration of an image generating apparatus that realizes a virtual machine according to one or more aspects of the present disclosure.

FIG. 5 is a block diagram showing an exemplary functional configuration of the virtual machine according to one or more aspects of the present disclosure.

FIG. 6 is a flowchart showing a processing example that is performed by the virtual machine according to one or more aspects of the present disclosure.

FIG. 7 is a flowchart showing a processing example of the communication terminal according to one or more aspects of the present disclosure.

FIG. 8 is a diagram showing an example of operation range information related to one or more aspects of the present disclosure a scroll operation.

FIG. 9 is a flowchart showing an example of communication necessity determination processing for a scroll operation.

FIG. 10 is a flowchart showing an example of communication necessity determination processing for a zoom operation.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

In the following embodiment, an information processing system that includes an image generating apparatus that renders Web pages, and an information processing apparatus that receives an image of a partial region of a Web page from the image generating apparatus and displays the image on a display unit is illustrated. When a user operation for changing an image displayed on the display unit is accepted, the information processing apparatus transmits information regarding the user operation to the image generating apparatus, and thereby obtains an image to which the user operation has been applied. Here, the information processing apparatus determines whether or not there will be a change in the image as a result of applying the user operation, and does not transmit the information regarding the user operation if it is determined that there will be no change. In the first embodiment, when the user performs a scroll operation on a screen that the user is viewing, the information processing apparatus (hereinafter, a “communication terminal”) that performs communication with the image generating apparatus (hereinafter, a “cloud browser”) determines whether or not there will be a change in the display screen, and determines whether or not communication with the cloud browser is necessary. If it is determined that communication is not necessary, unnecessary communication between the cloud browser and the communication terminal is prevented or reduced by restricting communication between the cloud browser and the communication terminal.

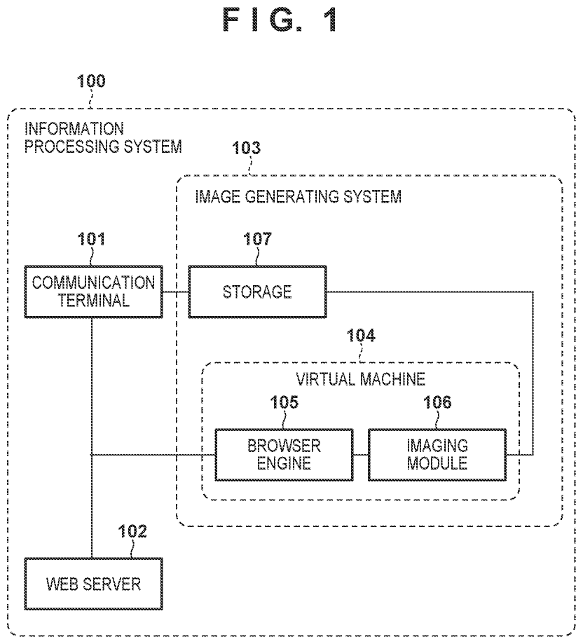

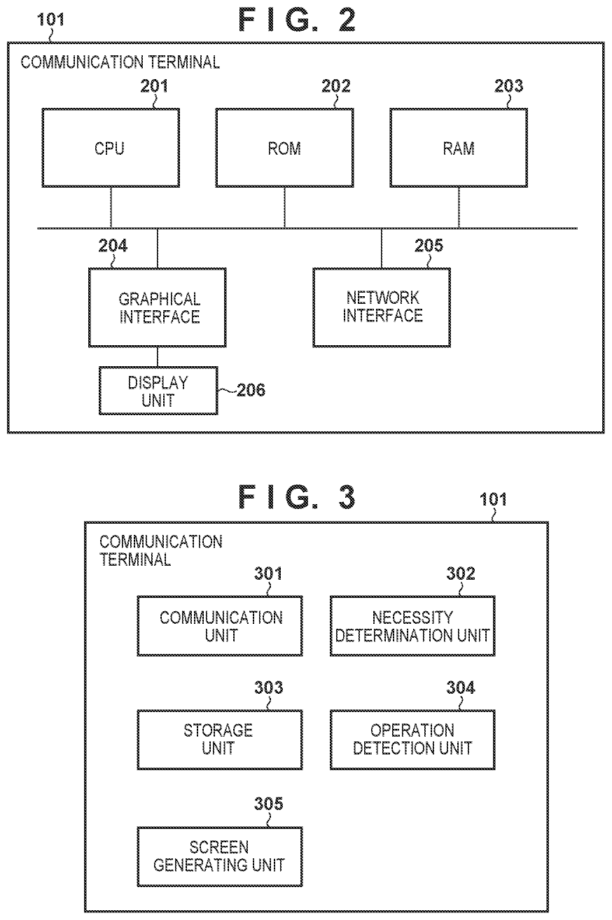

FIG. 1 is a block diagram showing a configuration example of an information processing system 100 according to the first embodiment. The information processing system 100 includes a communication terminal 101, a Web server 102, and an image generating system 103. The Web server 102 and the image generating system 103 function as a cloud browser. The communication terminal 101 is connected to the image generating system 103 via a network, receives an image of a Web page obtained by a browser engine 105 rendering a Web page, and displays the image on a display unit 206 (FIG. 2). The user can view Web content and perform an operation via the display unit 206 of the communication terminal 101. The communication terminal 101 transmits operation information indicating a user operation to the image generating system 103. The network is composed one of the Internet, a wide area network (WAN), and a local area network (LAN), or a combination thereof, for example. In addition, there may be a plurality of communication terminals.

The Web server 102 provides a Web page to the communication terminal 101 and the image generating system 103. The image generating system 103 is an example of a cloud browser, and includes a virtual machine 104, the browser engine 105, an imaging module 106, and a storage 107. The image generating system 103 may be constituted by one apparatus, or may be constituted by a plurality of apparatuses.

The virtual machine 104 has the browser engine 105 and the imaging module 106 implemented therein, and operates on the image generating system 103. The virtual machine 104 receives operation information from the communication terminal 101. In addition, the virtual machine 104 obtains a Web page from the Web server 102. The browser engine 105 operates on the virtual machine 104, analyzes the Web page obtained from the Web server 102, and renders the Web page. The imaging module 106 creates an image of a result of the browser engine 105 rendering the Web page, and transmits the image to the storage 107. The storage 107 operates on the image generating system 103, receives the image of the rendering result sent from the imaging module 106, and records the image. Note that there may be a plurality of storages 107.

FIG. 2 is a block diagram showing an exemplary hardware configuration of an information processing apparatus (computer apparatus) that constitutes the communication terminal 101 according to the first embodiment. A central processing unit (CPU) 201 controls the communication terminal 101. A read only memory (ROM) 202 stores programs and parameters that do not need to be changed. A random access memory (RAM) 203 temporarily stores programs and data supplied from an external apparatus or the like. A graphical interface 204 includes the display unit 206 for displaying various types of data, a pointing device such as a mouse, an input device such as a keyboard, and a touch panel provided on a display screen of the display unit 206. A network interface 205 connects the communication terminal 101 to a network. Note that the communication terminal 101 may include a hard disk, a memory card, and the like installed in a fixed manner. In addition, the communication terminal 101 may include an external storage device for connecting a removable storage medium thereto. Examples of such a storage medium include optical disks such as a flexible disk (FD) and a compact disk (CD), a magnetic/optical card, an IC card, and a memory card.

FIG. 3 is a block diagram showing an exemplary functional configuration of the information processing apparatus (computer apparatus) that is used as the communication terminal 101 according to the first embodiment. A communication unit 301 controls communication that is performed by the communication terminal 101 via the network interface 205. A necessity determination unit 302 determine whether or not there is a need to perform communication with a cloud browser (the image generating system 103). A storage unit 303 stores range information of a user operation of a rendering result. An operation detection unit 304 detects operation content when an operation is performed on the graphical interface 204. A screen generating unit 305 generates a screen that is displayed on the display unit 206 of the graphical interface 204, and performs display control of the display unit 206.

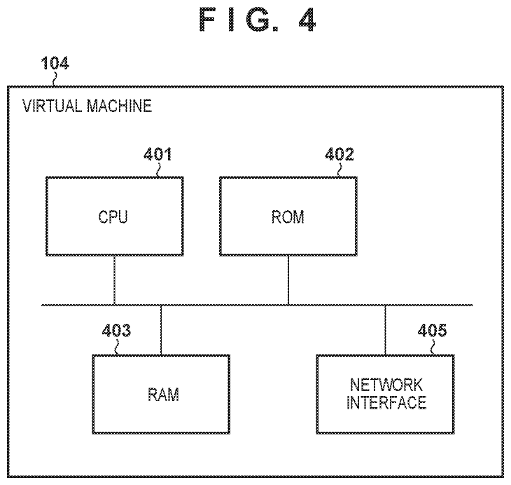

FIG. 4 is a block diagram showing an exemplary hardware configuration of an image generating apparatus (computer apparatus) that constitutes the virtual machine 104 according to the first embodiment. A central processing unit (CPU) 401 controls the virtual machine 104. A read only memory (ROM) 402 stores programs and parameters that do not need to be changed. A random access memory (RAM) 403 temporarily stores programs and data supplied from an external storage device or the like. A network interface 405 connects the virtual machine 104 to the network.

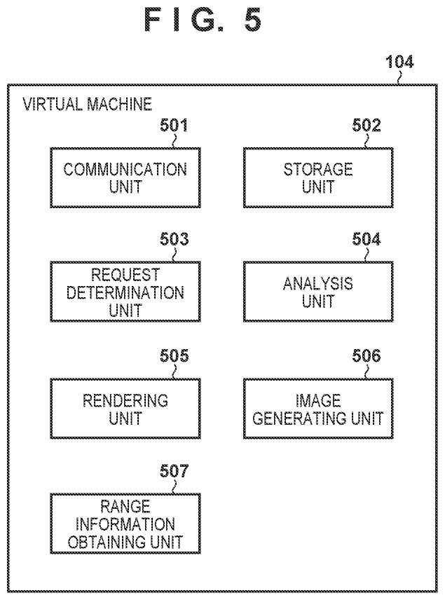

FIG. 5 is a block diagram showing an exemplary functional configuration of the virtual machine 104 according to the first embodiment. A communication unit 501 controls communication that is performed by the virtual machine 104 via the network interface 404. A storage unit 502 stores Web content and Web page information obtained from the Web server 102. A request determination unit 503 determines a type of request received by the communication unit 501. An analysis unit 504 analyzes a Web page obtained from the Web server 102. A rendering unit 505 renders the Web page analyzed by the analysis unit 504. An image generating unit 506 generates an image that is a result of rendering performed by the rendering unit 505. The analysis unit 504 and the rendering unit 505 are examples of a function unit that constitutes the browser engine 105, and the image generating unit 506 is an example of a function unit that constitutes the imaging module 106. A range information obtaining unit 507 obtains range information indicating a range of a Web page rendered by the rendering unit 505 in which a user operation can be performed and setting values of the browser engine.

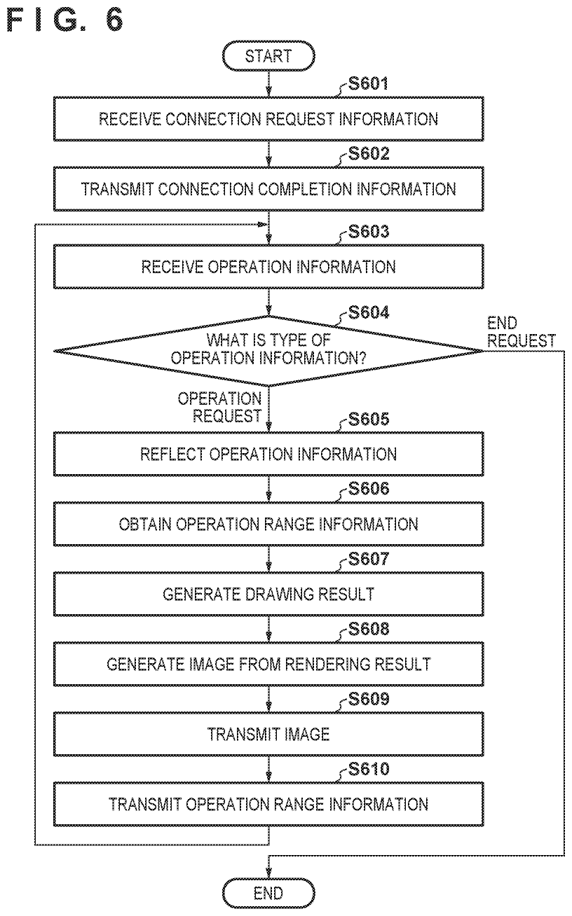

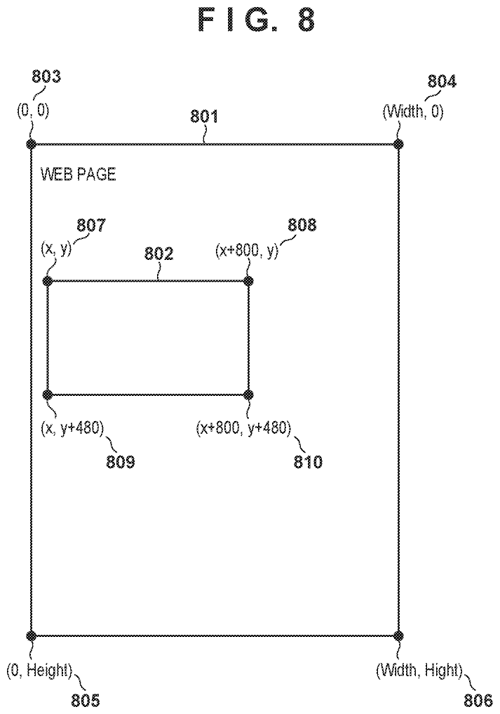

FIG. 6 is a flowchart illustrating a processing example of the virtual machine 104 according to the first embodiment. In step S601, the communication unit 501 receives a connection request from the communication terminal 101. The communication unit 501 communicably connects the communication terminal 101 and the virtual machine 104 (cloud browser) in accordance with the connection request. When connection is complete, the communication unit 501 transmits connection completion information to the communication terminal 101 in step S602. Note that, in step S602, the communication unit 501 transmits, to the communication terminal 101, an image of a region (default region) to be displayed, which is a portion of a Web page generated by the image generating unit 506. In addition, in step S602, the communication unit 501 transmits operation range information at this point in time (operation range information corresponding to an initial region) to the communication terminal 101. The operation range information will be described later with reference to FIG. 8.

In step S603, the communication unit 501 receives operation information from the communication terminal 101. In the present embodiment, operation information is information indicating an operation performed by the user on the graphical interface 204 of the communication terminal 101, and is the coordinate position of a click operation, the direction of a scroll operation, or the like. In step S604, the request determination unit 503 determines whether or not the type of the operation information received by the communication unit 501 is an operation request. If the received operation information is an operation request, the procedure advances to step S605, and if the received operation information is an end request, this processing ends. Note that, as this processing ends, connection with the communication terminal 101 also ends.

In step S605, the operation information received by the communication unit 501 is reflected. If the content of the operation information is click, for example, the analysis unit 504 performs processing for determining a user operation range changed in accordance with a click operation (coordinate position), in the Web page. In addition, if the content of the operation information is a scroll operation, the analysis unit 504 determines a user operation range after the scroll operation in the Web page. The user operation range is a partial region in the Web page, and is a region of an image that is displayed on the display unit 206 of the communication terminal 101. In step S606, the analysis unit 504 obtains the operation range information indicating the user operation range on which the operation information is reflected. The operation range information will be described later with reference to FIG. 8.

In step S607, the rendering unit 505 generates a rendering result on which the operation information was reflected in step S605. That is to say, the rendering unit 505 generates a rendering result for the user operation range moved in the Web page based on the operation information. In step S608, the image generating unit 506 creates an image of the rendering result generated by the rendering unit 505, and generates an image file. In step S609, the communication unit 501 transmits the image file generated in step S608 to the storage 107. In step S610, the communication unit 501 transmits the operation range information obtained in step S606 to the communication terminal 101 as an operation result of the user operation.

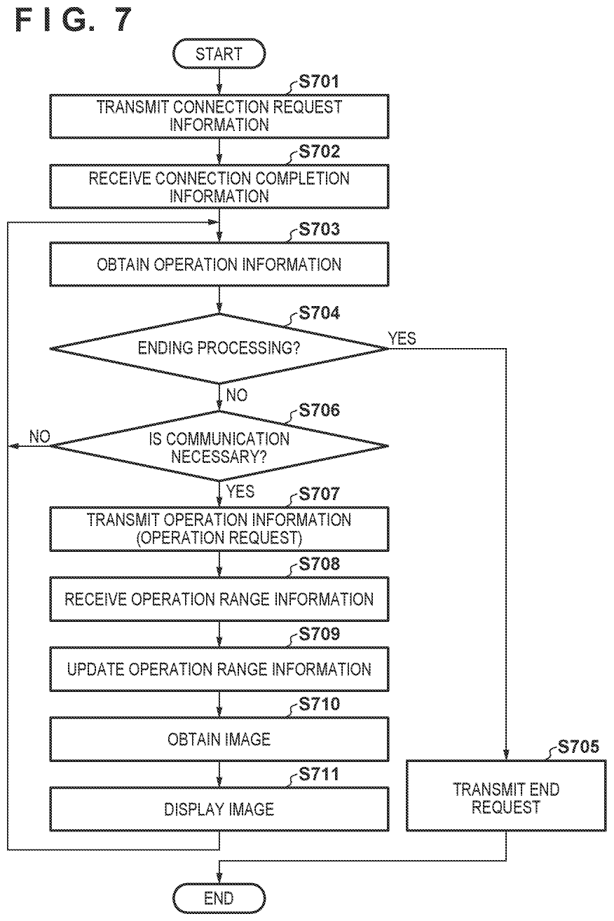

FIG. 7 is a flowchart illustrating a processing example of the communication terminal 101 according to the present embodiment. When the communication terminal 101 is instructed by the user to perform connection with the virtual machine 104 (cloud browser), the operation detection unit 304 detects this instruction and transmits a connection request to the virtual machine 104 via the communication unit 301, in step S701. The virtual machine 104 accepts the connection request, performs connection with the communication terminal 101 (step S601), and transmits connection completion information when connection is complete (step S602). In step S702, the communication unit 301 receives this connection completion information from the virtual machine 104. Note that, in step S702, the communication unit 301 receives an image of the initial region and the operation range information transmitted in step S602. The received image is displayed on the display unit 206 through display control performed by the screen generating unit 305.

In step S703, the operation detection unit 304 detects a user operation performed via the graphical interface 204, and obtains operation information. Examples of user operation include a click operation performed by operating a mouse or a touch panel, a scroll operation, a zoom operation, and the like that are performed through a software key operation or a physical key operation. In step S704, the operation detection unit 304 determines whether or not the operation information obtained in step S703 indicates ending processing. If it is determined that the operation information indicates ending processing (YES in step S704), the procedure advances to step S705. In step S705, the communication unit 301 transmits an end request to the virtual machine 104, and ends this processing. Note that, as this processing ends, connection with the virtual machine 104 also ends.

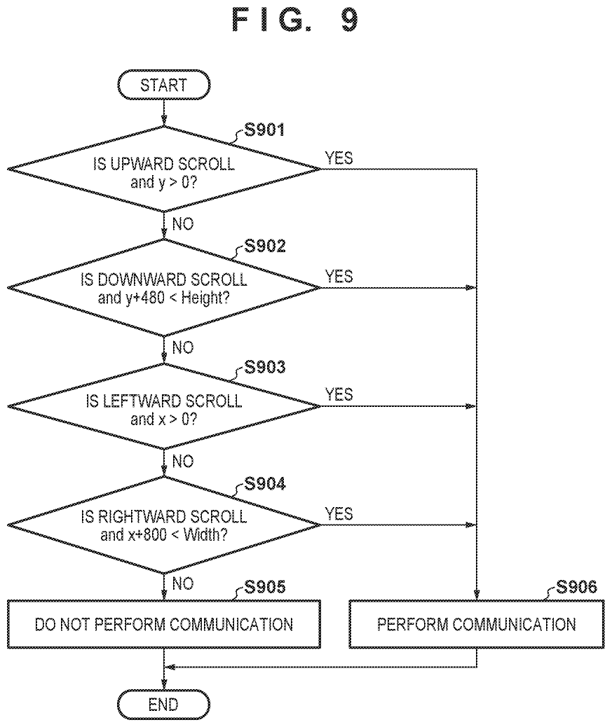

On the other hand, if it is determined that the operation information obtained in step S703 is an operation request, instead of ending processing (NO in step S704), the procedure advances to step S706. If, in step S706, the user operation is an operation requesting that the image that is being displayed is to be changed, the necessity determination unit 302 determines whether or not there will be a change in the image as a result of applying the user operation, and, based on this determination result, determines whether or not communication with the virtual machine 104 is necessary. If it is determined that communication is necessary (YES in step S706), the procedure advances to in step S707, and, if it is determined that communication is not necessary (NO in step S706), the procedure advances to step S703. In the present embodiment, it is assumed that a scroll operation has been performed, and, based on whether or not there will be a change in the image as a result of the scroll operation, determination is performed as to whether or not communication is necessary. This processing will be described later in detail with reference to FIG. 9.

In step S707, the communication unit 301 transmits the operation information obtained by the operation detection unit 304 (step S703), to the virtual machine 104. This operation information is determined as an operation request in step S604. In step S708, the communication unit 301 receives the operation range information as an operation result obtained based on the operation information transmitted in step S707. In step S709, the communication unit 301 updates the operation range information stored in the storage unit 303, to the operation range information received in step S708. In step S710, the communication unit 301 obtains the image file stored in the storage 107. The image file is an image file generated by the image generating unit 506 of the virtual machine 104 and stored in the storage 107, and includes an image corresponding to the updated user operation range. In step S711, the screen generating unit 305 displays the image of the image file obtained in step S710, on the display unit 206 of the graphical interface 204.

FIG. 8 shows an example of operation range information that is obtained by the range information obtaining unit 507 according to the present embodiment. In this example, the operation range information includes information regarding the size of a Web page and information regarding the current scroll position in the Web page. In FIG. 8, for example, size information of a Web page 801 to be viewed is expressed by coordinates 803 to 806. The size information indicates a range in which a region 802 can be moved (changed). In addition, for example, information regarding the current scroll position in the Web page 801 is expressed by coordinates 807 to 810. The Web page 801 in this example has a size expressed by the width x the height. In addition, the region 802 specified by the coordinates 807 to 810 is a partial region of the Web page, and indicates a region (display region) that is displayed on the display unit 206 of the communication terminal 101, and, in this example, the size of the display region is 800 pixels×480 pixels.

The coordinates 803 indicate the coordinates of the leftmost upper portion of the Web page 801, and are (0,0). The coordinates 804 indicate the coordinates of the rightmost upper portion of the Web page 801, and are (width,0). The coordinates 805 indicate the coordinates of the leftmost lower portion of the Web page 801, and are (0,height). The coordinates 806 indicate the coordinates of the rightmost lower portion of the Web page 801, and are (width,height). In addition, the coordinates 807 indicate the coordinates of the leftmost upper portion of the region 802, and the coordinates are expressed as (x,y). The coordinates 808 indicate the coordinates of the rightmost upper portion of the region 802, and are (x+800, y). The coordinates 809 indicate the coordinates of the leftmost lower portion of the region 802, and are (x, y+480). The coordinates 810 indicate the coordinates of the rightmost lower portion of the region 802, and are (x+800, y+480). Note that the width value and height value can be obtained respectively from JavaScript document.documentElement.clientWidth property and document.documentElement.clientHeight property, for example. In addition, the value of x and the value of y can be obtained respectively from JavaScript window.scrollX property and window.scrollY property, for example.

FIG. 9 is a flowchart showing detailed communication necessity determination processing for a scroll operation (step S706) according to the first embodiment. In the present embodiment, when at least one side of the region 802 at the current position matches an edge of the Web page 801, and the direction of movement indicated by the scroll operation is a direction toward the outside of the Web page 801, it is determined that the region 802 cannot be moved. First, in step S901, if the operation information obtained in step S703 indicates an upward scroll operation, the necessity determination unit 302 determines whether or not upward scroll can be performed, based on the operation range information received in step S708, and determines whether or not communication related to upward scroll is necessary. If the current scroll position y is larger than 0 (YES in step S901), upward scroll can be performed, and thus the procedure advances to step S906. On the other hand, if the current scroll position y is equal to 0 (NO in step S901), further upward scroll cannot be performed, and thus there will be no change in the image as a result of the upward scroll operation. Therefore, it is determined that communication related to the upward scroll operation is unnecessary, and the procedure advances to step S902.

In step S902, if the operation information obtained in step S703 indicates a downward scroll operation, the necessity determination unit 302 determines whether or not downward scroll can be performed, based on the operation range information received step S708, and determines whether or not communication is necessary. The current scroll position is denoted by y, and the size in the y direction of the region 802 is 480. Therefore, if y+480 is smaller than the height of the Web page 801 (YES in step S902), downward scroll can be performed, and thus the procedure advances to step S906. On the other hand, if y+480 is equal to size information, namely, the height of the Web page (NO in step S902), further downward scroll cannot be performed, and there will be no change in the image as a result of the downward scroll operation. Therefore, it is determined that communication related to the downward scroll operation is unnecessary, and the procedure advances to step S903.

In step S903, if the operation information obtained in step S703 indicates a leftward scroll operation, the necessity determination unit 302 determines whether or not leftward scroll can performed, based on the operation range information received in step S708, and determines whether or not communication is necessary. If the current scroll position x is larger than 0 (YES in step S903), leftward scroll can be performed, and thus the procedure advances to step S906. On the other hand, if the current scroll position x is equal to 0 (NO in step S903), further leftward scroll cannot be performed, and there will be no change in the image as a result of the leftward scroll operation. Therefore, it is determined that communication related to the leftward scroll user operation is unnecessary, and the procedure advances to step S904.

In step S904, if the operation information obtained in step S703 indicates a rightward scroll operation, the necessity determination unit 302 determines whether or not rightward scroll can be performed, based on the operation range information received in step S708, and determines whether or not communication is necessary. The current scroll position is denoted by x, and the size in the x direction of the region 802 is 800. Therefore, if x+800 is smaller than the width of the Web page 801 (YES in step S904), rightward scroll can be performed, and thus the procedure advances to step S906. On the other hand, if x+800 is equal to the width (NO in step S904), further rightward scroll cannot be performed, and there will be no change in the image as a result of the rightward scroll operation. Therefore, it is determined that communication related to the rightward scroll operation is unnecessary, and the procedure advances to step S905.

In step S905, the necessity determination unit 302 determines that there is no need to transmit the operation information to the virtual machine 104. In this case, in step S706 in FIG. 7, the procedure branches to NO to return to step S703, and the operation information is not transmitted. On the other hand, in step S906, the necessity determination unit 302 determines that there is a need to perform communication with the virtual machine 104. In this case, in step S706 in FIG. 7, the procedure branches to YES, and the processing of step S707 onward is executed in order to transmit the operation information.

As described above, according to the first embodiment, the communication terminal 101 determines whether or not communication with the virtual machine 104 is necessary, based on a user operation detected by the operation detection unit 304 and operation range information received from the cloud browser (the virtual machine 104). Accordingly, if there will be no change in the image as a result of the user operation, it is possible to restrict communication for updating the image between the virtual machine 104 and the communication terminal 101, and to reduce or prevent the occurrence of unnecessary communication. Note that, in the above embodiment, not transmitting operation information has been illustrated as an aspect for restricting communication, but there is no limitation thereto. It suffices for the communication amount to be reduced in restricted communication more than usual, and, for example, a configuration may be adopted in which only notification of operation information is performed, without receiving information from the cloud browser.

### Second Embodiment

In the first embodiment, a configuration has been described in which, when a scroll operation is accepted by the communication terminal 101 as a user operation for changing an image, determination is performed as to whether or not there will be a change in the image, and, based on this, determination is performed as to whether or not communication with the cloud browser is necessary. In a second embodiment, a configuration is described in which, when a zoom operation is accepted as a user operation for changing an image, determination is performed as to whether or not communication with the cloud browser is necessary. The configuration of the information processing system 100 and the hardware configurations and the software configurations of the communication terminal 101 and the virtual machine 104 according to the second embodiment are similar to those in the first embodiment (FIGS. 1 to 5). In addition, overall processing that is performed by the virtual machine 104 and the communication terminal 101 is also similar to the first embodiment (FIGS. 6 and 7). It should be noted that the operation range information that is obtained in step S606 is composed of the maximum value (Max), a default value (Default), and the minimum value (Min) of a zoom value range. The zoom value range indicates a range in which a zoom value can be changed. These values can be determined, for example, based on setting values of the browser engine 105. Note that the current zoom value z is also obtained as operation range information.

The communication terminal 101 according to the second embodiment determines that there will be no change in the image when a zoom operation instructed by the user instructs that the zoom value be changed to the outside the zoom value range, and determines that there will be a change in the image when the zoom operation instructs that the zoom value be changed within the zoom value range.

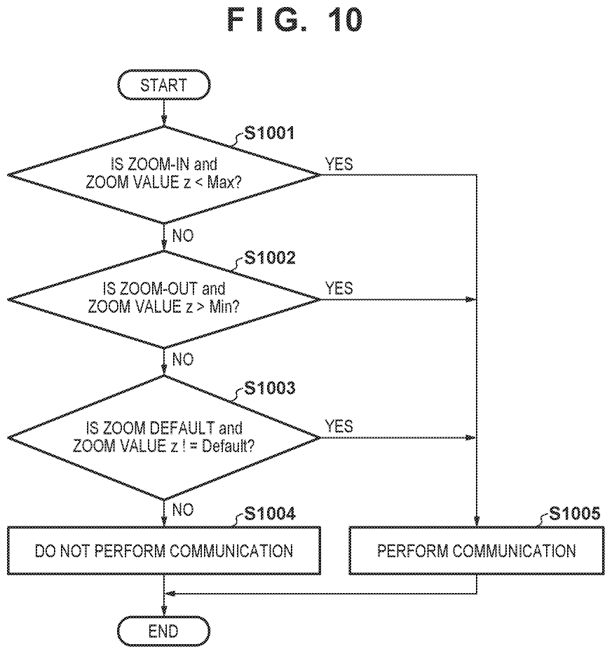

FIG. 10 is a flowchart illustrating communication necessity determination processing for a zoom operation (step S706) according to the second embodiment. In step S1001, if the operation information obtained in step S703 indicates a zoom-in operation, the necessity determination unit 302 determines whether or not zoom-in can be performed, based on the operation range information received in step S708, and determines whether or not communication is necessary. In step S1001, when the current zoom value is at the upper limit of the zoom value range, and the zoom operation instructs that the zoom value be increased, it is determined that there will be no change in the image. If the current zoom value z is smaller than the maximum value (Max) of the zoom value range (YES in step S1001), for example, zoom-in can be performed, and thus the procedure advances to step S1005. On the other hand, if the current zoom value z is equal to Max (NO in step S1001), further zoom-in cannot be performed, and thus there will be no change in the image as a result of the zoom-in operation. Therefore, the procedure advances to step S1002.

In step S1002, if the operation information obtained in step S703 indicates zoom-out, the necessity determination unit 302 determines whether or not zoom-out can be performed, based on the operation range information received in step S708, and determines whether or not communication is necessary. In step S1002, when the current zoom value is at the lower limit of the zoom value range, and the zoom operation instructs that the zoom value be decreased, it is determined that there will be no change in the image. If the current zoom value z is larger than the minimum value (Min) of the zoom value range (YES in step S1002), for example, zoom-out can be performed, and thus the procedure advances to step S1005. On the other hand, if the current zoom value z is equal to Min (NO in step S1002), further zoom-out cannot be performed, and thus there will be no change in the image as a result of a zoom-out operation. Therefore, the procedure advances to step S1003.

In step S1003, if the operation information obtained in step S703 indicates zoom reset, the necessity determination unit 302 determines whether or not zoom reset can be performed, based on the operation range information received in step S708, and determines whether or not communication is necessary. That is to say, in step S1003, when the zoom operation is an operation for returning the zoom value to the default value, and the current zoom value is the default value, it is determined that there will be no change in the image, and if the current zoom value is not the default value, it is determined that there will be a change in the image. If the current zoom value z is different from the default value (YES in step S1003), for example, there will be a change in the image as a result of zoom reset, and thus the procedure advances to step S1005. On the other hand, if the current zoom value z is equal to the default value (NO in step S1003), zoom reset cannot be performed, and thus the procedure advances to step S1004.

In step S1004, the necessity determination unit 302 determines that there is no need to perform communication with the virtual machine 104. Thus, in step S706 in FIG. 7, the procedure branches to NO to return to step S703. For this reason, communication for the operation information is not executed. On the other hand, in step S1005, the necessity determination unit 302 determines that there is a need to perform communication with the virtual machine 104. As a result, in step S706 in FIG. 7, the procedure branches to YES, and operation information is transmitted through processing of step S707 onward.

As described above, according to the second embodiment, determination can be performed as to whether or not communication with the virtual machine 104 is necessary, based on the operation range information obtained in step S606. Accordingly, it is possible to reduce or prevent the occurrence of unnecessary communication between the communication terminal 101 and the virtual machine 104.

Note that scroll operations have been described in the first embodiment, and zoom operations have been described in the second embodiment, but the present disclosure is not limited to these operations. The technique according to the present disclosure is also applicable to a resize operation for changing the size of an image that is generated, for example. In a case of the resize operation, the necessity determination unit 302 (step S706) determines whether or not there will be a change in the image, based on the current resize state and a resizable range, and, based on this determination, determines whether or not communication is necessary. The current resize state and the resizable range can be obtained from the image generating system 103 (cloud browser) as the above-described operation range information. In addition, the technique according to the present disclosure is also applicable to a click operation, for example. In this case, when a click operation is accepted, the necessity determination unit 302 (step S706) determines whether or not there will be a change in the image, based on a region of Web content for an instruction that causes a change in the image and a position at which a click operation was performed. The position of the region of Web content that is used for determining whether or not communication is necessary, and is subject to a change in the image as a result of click is obtained as operation range information from the image generating system 103.

In addition, in the above embodiments, the necessity determination unit 302 of the communication terminal 101 obtains information required for determining whether or not there will be a change in the image (for example, in the first embodiment, the size of the Web page 801 and the position of the region 802), from the image generating system 103. However, the technique in the present disclosure is not limited thereto, and the necessity determination unit 302 may hold and update operation range information required for the determination. A configuration may also be adopted in which, for example, when an image of the Web page 801 is received, the size of the Web page 801 and the initial position of the region 802 are obtained, and the necessity determination unit 302 updates the position of the region 802 in accordance with a user operation. With such a configuration, without receiving updated operation range information from the image generating system 103, it is possible to determine whether or not there will be a change in the image as a result of a user operation.

As described above, according to the above embodiments, when a user operation for changing an image displayed on the display unit 206 is accepted, the communication terminal 101 determines whether or not there will be a change in the image as a result of applying the user operation, and restricts transmission of information regarding the user operation if there will be no change in the image. Accordingly, the occurrence of unnecessary communication is reduced or prevented.

According to the present disclosure, the occurrence of communication that occurs in accordance with a user operation is reduced, in a configuration for receiving an image of a Web page from an external apparatus and displaying the image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as ‘anon-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-181243, filed Nov. 11, 2022, which is hereby incorporated by reference herein in its entirety.

What is claimed is:

1. An information processing apparatus comprising:
a display control unit configured to receive an image of a partial region of a Web page, from an external image generating apparatus that renders the Web page, and to display the image on a display unit;
a determining unit configured to, when a user operation for changing the image displayed on the display unit is accepted, determine whether or not there will be a change in the image as a result of applying the user operation; and
a transmitting unit configured to transmit information regarding the user operation to the image generating apparatus in order to obtain an image to which the user operation has been applied,
wherein if it is determined that there will be no change in the image, the transmitting unit restricts transmission of the information regarding the user operation to the image generating apparatus.

2. The information processing apparatus according to claim 1,
wherein the determining unit determines whether or not there will be a change in the image, by determining whether or not there will be a change in the region as a result of applying the user operation.

3. The information processing apparatus according to claim 2,
wherein the determining unit determines whether or not there will be a change in the region as a result of applying the user operation, based on information regarding a range in which the region is changeable in accordance with the user operation, and current information related to the region.

4. The information processing apparatus according to claim 3, further comprising
an obtaining unit configured to obtain the information regarding the range and the current information from the image generating apparatus.

5. The information processing apparatus according to claim 3,
wherein the information regarding the range indicates a size of the Web page and the current information indicates a current position of the region in the Web page, or the information regarding the range indicates a range of a zoom value and the current information indicates a current zoom value.

6. The information processing apparatus according to claim 1,
wherein the user operation is a scroll operation instructing that a current position of the region in the Web page be changed, and
the determining unit determines whether or not there will be a change in the image, based on a direction of movement instructed by the scroll operation, and the current position of the region in the Web page.

7. The information processing apparatus according to claim 6,
wherein, when at least one side of the region at the current position matches an edge of the Web page, and a direction of movement indicated by the scroll operation is a direction outward of the edge of the Web page, it is determined that it is not possible to move the region.

8. The information processing apparatus according to claim 6, further comprising:
an obtaining unit configured to obtain information regarding a size of the Web page and the current position of the region in the Web page, from the image generating apparatus.

9. The information processing apparatus according to claim 1,
wherein the user operation is a zoom operation for changing a size of the region, and
the determining unit determines that there will be no change in the image if the zoom operation instructs that a zoom value be changed to a value outside a zoom value range, and determines that there will be a change in the image if the zoom operation instructs that the zoom value be changed within the zoom value range.

10. The information processing apparatus according to claim 9,
wherein the determining unit determines that there will be no change in the image if a current zoom value is at an upper limit of the zoom value range and the zoom operation instructs that the zoom value be increased, or if the current zoom value is at a lower limit of the zoom value range and the zoom operation instructs that the zoom value be decreased.

11. The information processing apparatus according to claim 10, further comprising
an obtaining unit configured to obtain the current zoom value and the zoom value range from the image generating apparatus.

12. The information processing apparatus according to claim 9,
wherein the determining unit determines there will be no change in the image if the zoom operation is an operation of returning the zoom value to a default value and a current zoom value is the default value, and determines there will be a change in the image if the current zoom value is not the default value.

13. An image generating apparatus comprising:
a rendering unit configured to analyze and render a Web page;
a generating unit configured to generate, based on a rendering result of the rendering unit, a partial region of the Web page that corresponds to an image of a region that is set based on operation information received from an external apparatus;
an obtaining unit configured to obtain current information of the region to which the operation information has been applied, and information regarding a range in which the region is changeable; and
a transmitting unit configured to transmit, to the external apparatus, the image generated by the generating unit, and the current information and the information regarding the range obtained by the obtaining unit.

14. The image generating apparatus according to claim 13,
wherein the information regarding the range is a size of the Web page and the current information is a current position of the region in the Web page, or the information regarding the range is a range of a zoom value and the current information is a current zoom value corresponding to a size of the region.

15. An information processing system comprising;
an image generating apparatus that generates, based on a rendering result of a Web page, a partial region of the Web page that corresponds to an image of the region that is set based on operation information from outside; and
an information processing apparatus that transmits the operation information to the image generating apparatus, receives the image of the region from the image generating apparatus, and displays the image on a display unit;
wherein, when a user operation for changing the image displayed on the display unit is accepted,
the information processing apparatus determines whether or not there will be a change in the image as a result of applying the user operation,
transmits the operation information indicating the user operation to the image generating apparatus if it is determined that there will be a change in the image, and
restricts transmission of operation information indicating the user operation to the image generating apparatus if it is determined that there will be no change in the image.

16. A method for controlling an information processing apparatus comprising:
performing control so as to receive an image of a partial region of a Web page, from an external image generating apparatus that renders the Web page, and to display the image on a display unit;
when a user operation for changing the image displayed on the display unit is accepted, determining whether or not there will be a change in the image as a result of applying the user operation; and
transmitting information regarding the user operation to the image generating apparatus in order to obtain an image to which the user operation has been applied,
wherein, in the transmitting, if it is determined that there will be no change in the image, transmission of the information regarding the user operation to the image generating apparatus is restricted.

17. A method for controlling an image generating apparatus, comprising:
analyzing and rendering a Web page;
generating, based on a rendering result in the rendering, a partial region of the Web page that corresponds to an image of a region that is set based on operation information received from an external apparatus;
obtaining current information of the region to which the operation information has been applied, and information regarding a range in which a state of the region is changeable; and
transmitting, to the external apparatus, the generated image and the obtained current information and information regarding the range.

18. A non-transitory computer-readable storage medium storing a program for causing a computer to execute a method for controlling an information processing apparatus, the method comprising:
performing control so as to receive an image of a partial region of a Web page, from an external image generating apparatus that renders the Web page, and to display the image on a display unit;
when a user operation for changing the image displayed on the display unit is accepted, determining whether or not there will be a change in the image as a result of applying the user operation; and
transmitting information regarding the user operation to the image generating apparatus in order to obtain an image to which the user operation has been applied,
wherein, in the transmitting, if it is determined that there will be no change in the image, transmission of the information regarding the user operation to the image generating apparatus is restricted.

19. A non-transitory computer-readable storage medium storing a program for causing a computer to execute a method for controlling an image generating apparatus, the method comprising:
analyzing and rendering a Web page;
generating, based on a rendering result in the rendering, a partial region of the Web page that corresponds to an image of a region that is set based on operation information received from an external apparatus;
obtaining current information of the region to which the operation information has been applied, and information regarding a range in which a state of the region is changeable; and
transmitting, to the external apparatus, the generated image and the obtained current information and information regarding the range.
